(19) United States
(12) Patent Application Publication
(10) Pub. No.: US 2023/0234878 A1
(43) Pub. Date: Jul. 27, 2023

(54) GLASS HANDLING DEVICES AND RELATED METHODS

(71) Applicant: ENTEGRIS, INC., Billerica, MA (US)

(72) Inventors: Manuel Frank Gonzales, Fort Worth, TX (US); Kellen Myers, Azle, TX (US); LaVon Hayes, Decatur, TX (US); Subhash Guddati, Singapore (SG); Thines Kumar Perumal, Singapore (SG); Aravind Vasanthakumar, Singapore (SG); Montray Leavy, Singapore (SG)

(21) Appl. No.: 18/099,684

(22) Filed: Jan. 20, 2023

Related U.S. Application Data
(60) Provisional application No. 63/302,227, filed on Jan. 24, 2022.

(51) Int. Cl. C03B 35/04; B33Y 80/00

(52) U.S. Cl. CPC C03B 35/04; B33Y 80/00; B28B 1/001

(57) ABSTRACT

Described is automated glass manufacturing equipment, and in particular to devices known as “takeout holders,” as well as systems that use the takeout holders and methods of making and using the takeout holders.

### FIELD

This description relates to automated glass manufacturing equipment, and in particular to devices known as “takeout holders.”

### BACKGROUND

Glass handling devices that are referred to as “takeout holders” are devices that are part of an automated glass handling system, and that engage with a piece of hot glass, while the glass is being manufactured at high temperature. Examples are described in U.S. Pat. Nos. 7,472,565, 7,418,834, 2013/0241222.

The takeout holder is a fixture that is attached to an end of an automated robotic arm that is used to lift and move a hot glass item such as a glass bottle. A pair of opposed takeout holders at the end of the arm, which are moveable by the arm, grasps the hot glass piece and lifts and carries the piece between stations, such as from a mold that forms the glass to a location away from the mold. The takeout holder must be able to withstand repetitive movement and extended cycles of contacting, grasping, moving, and releasing a glass item at a high temperature.

Common takeout holders are prepared of metal and the hot glass items are susceptible to being damaged by contact with the metal takeout holder. To reduce the chance that the metal takeout holder may damage a hot glass item, the takeout holder includes a replaceable “insert” at locations that contact the hot glass piece. The replaceable insert is made of heat-resist non-metal material such as asbestos, carbon fiber, and graphite.

The takeout holder is a shaped part that includes, generally: an upper portion or “connector” that attaches to the end of the robotic arm, a lower portion or “base” that is adapted to hold a heat-resistant insert that contacts a hot glass item, and a “body” that extends between the upper portion and the lower portion. Commercial glass takeout holders are commonly made of metal such as stainless steel, and are formed by machining a larger piece of metal to form the various upper portion, lower portion, and body. The holder, made of machined metal, is substantially dense and heavy. This process to form the part requires a significant amount of machining and multiple setups to hold critical tolerances, and standard forming techniques limit the design of the takeout holder. Machining processes are expensive and require a significant amount of time to complete the takeout holder.

In use, these heavy metal takeout holders result in strain and wear at an end of a robotic arm, specifically to a “tong head” or “actuators” that hold and manipulate the holders during a glass manufacturing process. Due in part to stress experienced by the tong head to manipulate a heavy holder, tong heads require extensive maintenance and replacement.

### SUMMARY

In one aspect, the following description relates to a glass handler holder (a.k.a. “takeout holder” or “holder”) that includes: a connector that comprises at least one tab; a body connected to the connector and extending toward a base; a base that includes an insert opening comprising a lower surface and an upper surface, wherein the glass handler holder comprises a multi-layer composite that includes weight-reducing openings formed in the connector, body, or base.

In another aspect, the description relates to a robotic arm that comprises an end, the end comprising a first glass handler holder comprising: a connector that comprises at least one tab, a body connected to the connector and extending toward a base, and a base connected to the base, the base comprising an insert opening includes a lower surface and an upper surface, wherein the first glass handler holder comprises a multi-layer composite that includes weight-reducing openings formed in the connector, body, or base; and a second glass handler holder comprising: a connector that comprises at least one tab, a body connected to the connector and extending toward a base, a base connected to the base, wherein the base comprises an insert opening that includes a lower surface and an upper surface, the second glass handler holder comprising a multi-layer composite that includes weight-reducing openings formed in the connector, body, or base.

In yet another aspect, the disclosure relates to a method of making a glass handler holder by additive manufacturing. The glass handler holder comprises: a connector that comprises at least one tab, a body connected to the connector and extending toward a base, a base that includes an insert opening comprising a lower surface and an upper surface, wherein the glass handler holder comprising a multi-layer composite that includes weight-reducing openings formed in the connector, body, or base.

### BRIEF DESCRIPTION OF THE DRAWINGS

FIGS. 1A and 1B show an example of a takeout holder as described.

FIGS. 2A and 2B show an example of a takeout holder as described.

FIGS. 3A, 3B, and 3C show an example of a takeout holder as described.

The figures are schematic and not drawn to scale.

### DETAILED DESCRIPTION

The following describes a device referred to as a “glass handler holder,” a “takeout holder” or simply a “holder.” The takeout holder is installed at an end of a robotic arm and is used to manipulate hot glass items such as hot glass bottles in automated glass-handling applications.

The described takeout holders are prepared by certain types of additive manufacturing techniques that are capable of producing holders to include structures having a reduced weight compared to holders prepared by previous methods. The described holders include weight-reducing openings within their structures, which may be in the form of a lattice, a hollow interior, or both, with the reduced weight producing reduced stress and wear on the robotic arm that supports the takeout holder when manipulating the hot glass items. The described additive manufacturing techniques are particularly effective for producing takeout holders that include these weight-reducing openings, due to the ability to produce the holder from feedstock that does not require a binder. Without the presence of a binder in the feedstock material, the holder can be prepared by additive manufacturing techniques that do not require a binder-removal step (e.g., a “debinding” step or a “debind” step), and that do not require a sintering step. Preferred additive manufacturing techniques are able to produce a holder that has near final dimensions, without the need for a debinding or sintering step, with the part requiring minimal post-processing machining steps.

The takeout holder prepared by an additive manufacturing technique can have a reduce mass, intricately-formed weight-reducing openings, hollow interior spaces, without modifying the external form of the part, and while maintaining a desired strength. Additionally, the additive manufacturing methods allow the holders to be prepared from a larger range of materials than is available for preparing holders by previous manufacturing methods. Advantages of the new design and method include efficient manufacturing, reduced mass, and prolonged life or reduced maintenance of a robotic arm (e.g., tong heads of the arm) that supports the holder during use.

A takeout holder is a known component of an automated system used to manipulate hot glass items such as hot, freshly-molded glass bottles. See, e.g.: U.S. Pat. Nos. 7,472,565, 7,418,834, 2013/0241222. A takeout holder is a shaped, replaceable part of the automated glass handling system that is attached and detached at an end of the robotic arm. The arm includes two opposed takeout holders that are moveable relative to each other, that can open and close around a glass piece to grasp and handle the glass piece. The takeout holder includes generally three “portions”: an upper portion, sometimes referred to as a “connector” that contacts and attaches to the end of the robotic arm; a lower portion or “base” that is adapted to hold a replaceable heat-resistant “insert” that contacts the hot glass item; and a central portion referred to as a “body” that extends between the upper portion (connector) and the lower portion (base).

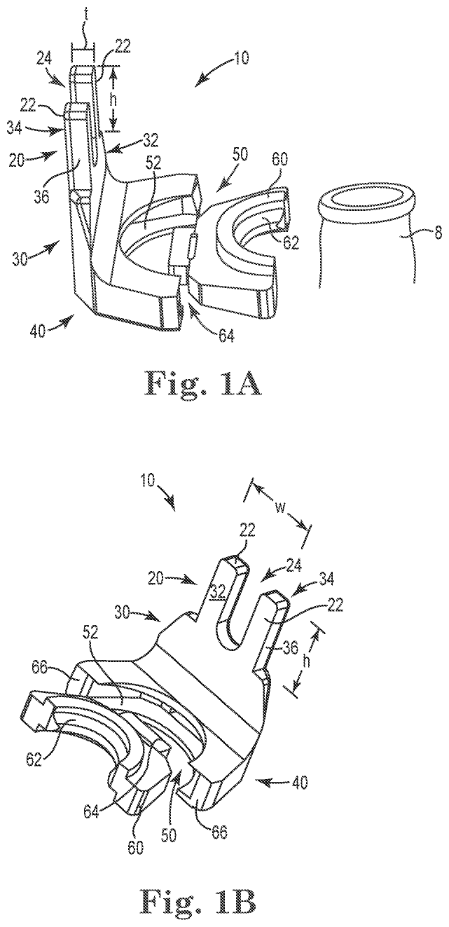

An example of a typical takeout holder and insert for manipulating a glass piece (illustrated as bottle 8) is shown at FIGS. 1A (top-side-perspective view) and 1B (top-front-perspective view). As illustrated, takeout holder 10 includes upper connector portion (“connector”) 20 comprising vertically-extending tabs 22, which define opening 24 (the tabs and opening may sometimes be referred to as a “yoke” or a “connecting yoke”). As a reference, this description will consider that tabs 22 extend vertically (up-and-down) along a height (h), extend laterally (horizontally) along a width (w), and have a thickness (t) also in the horizontal direction. Also as a reference, “front” surface 32 is a surface of a connector, base, or body portion that faces toward insert 60 and bottle 8, and “back” surface 34 is a surface of a connector, base, or body portion that faces away from insert 60 and bottle 8. “Side” surfaces 36 are the surfaces that are located between and that horizontally connect the edges of the front and back surfaces.

Example body portion (“body”) 30, situated below connector 20 in the vertical (height) direction, extends vertically down, parallel to tabs 22, and ends at a lower portion or “base” 40. Base 40 has a height and also extends laterally i.e., horizontally, and includes insert opening 50, which includes a lower horizontal surface (52) and an upper horizontal surface (not visible). In use, insert 60 includes a front surface 62 that is designed to contact a hot glass device such as bottle 8 during use, and includes a back portion 64 that is adapted to fit within insert opening 50 to secure insert 60 to base 40 of holder 10 at insert opening 50.

Example holder 10 illustrated at FIGS. 1A and 1B is merely illustrative. Other example holders may include a base, a body, or a connector that is varied in relative size or shape compared to those of example holder 10. For example, base 40 of holder 10 includes a curved or semi-circular form on a front side that includes insert opening 50 and upper and lower surfaces 52 and 54. A base and insert opening as illustrated, that have a curved or semi-circular form, are sometimes referred to as a “jaw.” According to other example holders, a base 40 can be a flat vertical extension of body 30 that does not include curved or semi-circular extensions in a horizontal direction, but includes an insert opening 50 (still including an upper horizontal surface and a lower horizontal surface) as part of the flat vertical base.

Example insert 60 has an inside surface 62 for contacting a hot glass piece, such as a circular neck of a glass bottle. Inside surface 62 can be flat, contoured to match a glass piece (e.g., bottle 8), or threaded to match bottle threads. Example insert 60 includes two flat vertical front-facing surfaces 66 that align with similar flat surfaces of an opposing insert held by an opposing takeout jaw.

Insert 60 is made from a heat-resistant material that is stable to withstand the elevated temperature of a hot glass piece while maintaining shape and function. In useful examples, insert 60 can be made of asbestos, carbon fiber, graphite, or a graphite-containing plastic, which may be machined or molded.

According to the invention, a takeout holder can be prepared by an additive manufacturing method that is able to prepare the holder to include one or more portions having weight-reducing openings.

A takeout holder prepared by an additive manufacturing method is made of solid structural material that is referred to as “solidified feedstock.” The solidified feedstock as solid structural material provides the rigid, solid structure of the holder and defines the general shape and outer form and outer surfaces of the holder. The outer surfaces define an overall shape and form of the holder and the different portions of the holder, including generally a “front” surface that has an area that faces a direction of an insert, a “back” surface that has an area that faces a direction away from the insert, and side (edge) surfaces that are located around a perimeter of the exterior of the holder.

A “weight-reducing opening” may be an open, non-solid space formed in a portion of a holder that is left open during an additive manufacturing step by the absence of solidified feedstock being formed at the location of the opening. The weight-reducing opening is a space formed by an absence of solidified feedstock material at a location in a volume of a portion of a holder, to reduce the total weight of the holder, but in a manner that will retain desired strength and functioning of the holder.

Example weight-reducing openings include spaces that are located internally within the volume of the holder, between (and “below”) exterior surfaces of the holder, i.e., empty or hollow interior spaces. These weight-reducing spaces will not be visible by viewing the exterior of the holder. An example of a type of hollow interior space that is effective as a weight-reducing space is a continuous space having a volume with one or more dimensions on a scale of a dimension of the holder, such as a continuous volume with a length, width, or height dimension of greater than 0.5 centimeter, 1 centimeter, or greater than 2 or 3 centimeters.

A different example of a hollow interior space that is effective as a weight-reducing opening is a “pore” or a collection of pores within a solid structure of a holder, for example a collection of random or irregularly-shaped, discontinuous or connected (or both) pores, channels, or other spaces (referred to generally as “pores”) that can be formed during an additive manufacturing step by feedstock particles being not completely melted, and therefore not combined into a continuous, non-porous solidified feedstock layer, during an additive manufacturing step. These pores are known to form during certain types of additive manufacturing techniques and can account for a significant volume (“pore volume” or “porosity”) of a multi-layer composite that is formed by an additive manufacturing technique. These weight-reducing openings will also not be visible by viewing the exterior of the holder.

Yet another example of a type of useful weight-reducing opening is in the form of small openings in a portion of a holder that are bounded by solid lattice structures formed of the solidified feedstock. Weight-reducing openings in the form of lattice openings are small-dimension spaces separated by small-dimension lattice members. The openings may be regularly-shaped or patterned, such as an opening in the form of a geometric shape such as a square, triangle, circle, oval, hexagon, or rectangle, that is part of a regular or repeating pattern of a lattice structure. The lattice is a framework or network of lattice members that are separated by and define openings between the members. The lattice members may be straight, curved, and may form a regular pattern. In useful examples of a lattice of a holder portion, the members and the lattice openings, which are weight-reducing openings as described, can exhibit at least one dimension that is small relative to the size of the holder. Example lattice members can have at least one dimension that is less than 3 centimeters, e.g., less than 1 centimeter or less than 0.5 centimeters. Example lattice openings can have at least one dimension that is less than 3 centimeters, e.g., less than 1 centimeter or less than 0.5 centimeters. Lattice openings can have an area, in two of its three dimensions, that is also relatively small, such as less than 1, 0.8, or 0.5 square centimeters.

Example lattice structures may be formed only at an interior space of a holder as hollow interior spaces. Alternately, a lattice structure may extend to surfaces of a holder and be visible at surfaces, as a visible structure of the holder. A volume of a lattice structure that is weight-reducing openings may be a volume of at least 5, 10, 20, 30, 40, 50, or 60 percent or more of the lattice structure, and a volume of a portion (e.g., connector, body) of a holder that contains a lattice structure may contain a volume of weight reducing-openings that is at least 5, 10, 20, 30, 40, 50, or 60 percent of the volume of the portion of the holder.

Example weight-reducing openings in the form of hollow interior spaces may be formed as lattice openings, but may also be formed as larger spaces that take up a significant volume of the portion of the holder, such as at least 5, 10, 20, 30, 40, 50, or 60 percent or more of a portion (e.g., connector, body) of a holder, and that portion may optionally include solid supports within the opening that do not necessarily form structure that is a lattice.

“Weight-reducing openings” as described do not include certain specific types of openings that have been previously included in a takeout holder for a purpose other than to remove mass from a holder to reduce the weight of the holder, including a space between tabs that form a yoke of a connector portion, a space of an insert opening, or a hole or opening used with a separate fastener piece to secure the holder to another structure, e.g., to secure an insert to an insert holder at a base portion.

In example holders, a portion of a holder (base, body, or connector) can include weight-reducing openings that are formed by an additive manufacturing technique that is capable of forming such weight-reducing structures, as described, to produce a holder that reduces total weight of the holder while still providing effective holder strength and performance. Example weight-reducing designs may be selected to form a portion of the holder from solidified feedstock material that is selectively placed within the structure of the holder portion to support a desired set of loads needed for use of the holder, with open space (weight-reducing openings) between the solidified feedstock to reduce total weight of the holder.

Example designs may be selected by a technique referred to as topology optimization, which may be performed using a computer-aided design algorithm that calculates useful structures of a holder portion that is made of a reduced amount of structural material (solidified feedstock), and therefore exhibits a reduced mass (weight), but still exhibits effective strength. A topology optimization technique is capable of designing a useful structure of the holder portion by identifying and eliminating solid material (solidified feedstock) at locations within the holder that do not need to carry significant loads. Designs produced with topology optimization may include solid structures that have a pattern of small-dimension support structures, such as lattice members, that are difficult or impossible to form using traditional production methods such as machining. A holder design prepared by a topology optimization technique, when carried out using an additive manufacturing technique that is capable of forming complex, small-dimension support members, hollow interior spaces, or both, is effective for forming a holder as described.

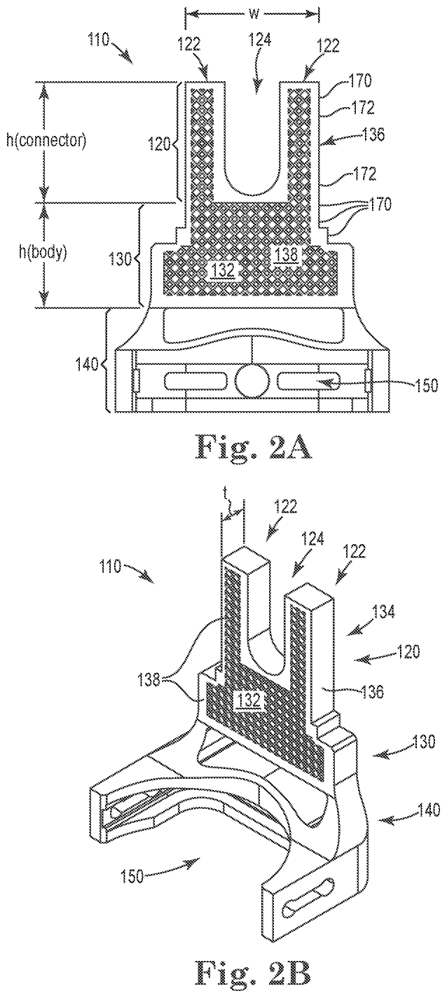

An example of a holder that includes weight-reducing openings in the form of lattice openings of a lattice structure is shown at FIGS. 2A (front view) and 2B (front-perspective view). Holder 110 includes connector 120 comprising vertically-extending tabs 122, which define opening 124. Tabs 122 extend vertically (up-and-down) along a height (h), extend laterally (horizontally) along a width (w), and have a thickness (t) also in the horizontal direction. Front surface 132 is a surface of connector 120 and body 130 that faces toward an insert (not shown) held in insert opening 150 of base 140. The “surface” is considered to include the entire area of connector 120 and body 130 between edges, including the surface area that includes openings of the lattice as well as the surface area that includes the lattice members. Back surface 134 (not visible) is a surface of connector 120 and body 130 that faces away from insert opening 150. Side surfaces 136 are the surfaces that are located between and that horizontally connect the edges of the front and back surfaces 132 and 134.

Connector 120 and body 130 have volumes between front and back surfaces 132 and 134 that contain lattice structure 138, the volume of the connector and body portions being calculated as including the volume of lattice openings 170 (weight-reducing openings as described) and the volume of solid lattice members 172, made of solidified feedstock. Weight-reducing openings 170 extend from front surface 132 to back surface 134, along thickness t of connector 120 and body 130, and have the effect of reducing the total mass (weight) of connector 120 and body 130, as well as holder 110, while still providing effective strength and rigidity to connector 120 and body 130.

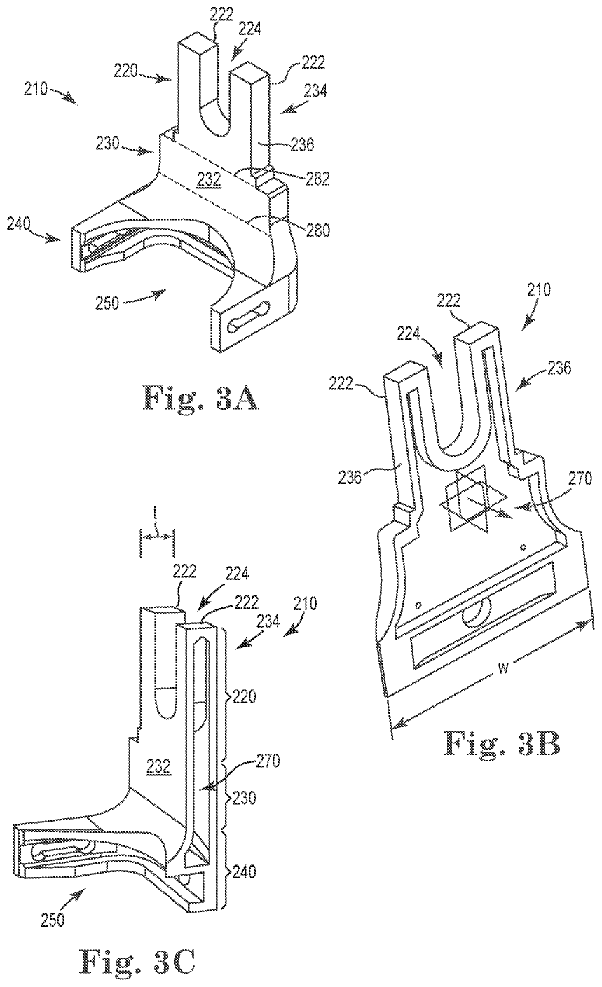

An example of a holder that includes a connector, body, and base that include weight-reducing openings in the form of a hollow interior, and continuous outer front and back surfaces, is shown at FIGS. 3A, 3B, and 3C.

FIG. 3A is a side perspective view of holder 220. FIG. 3B is a cross-sectional view of holder 220 in a vertical plane in a width direction of holder 220. FIG. 3C is a cross-sectional view in a vertical plane in a thickness direction of holder 220.

Holder 210 includes connector 220 comprising vertically-extending tabs 222, which define opening 224. Tabs 222 extend vertically (up-and-down) along a height (h), extend laterally (horizontally) along a width (w), and have a thickness (t) also in the horizontal direction. Front surface 232 is a surface of connector 220 and body 230 that faces toward an insert (not shown) held in insert opening 250 of base 240. Back surface 234 (not visible) is a surface of connector 220 and body 230 that faces away from insert opening 250. Side surfaces 236 are the surfaces that are located between and that horizontally connect the edges of the front and back surfaces 232 and 234.

Holder 210 includes weight-reducing opening 270 in the form of a hollow interior contained within connector 220, body 230, and base 240. Weight-reducing opening 270 extends between front surface 232 and back surface 234, along the thickness of connector 220, body 230, and base 240, and along a portion of the height of connector 220, body 230, and base 240. Weight-reducing opening 270 has the effect of reducing the total mass (weight) of connector 220, body 230, and base 240, as well as holder 210, while the overall structures and exterior form of these portions and of holder 220 still provide effective strength and rigidity for holder 220.

A portion of a holder (a connector portion, a body portion, or a base portion) that contains weight-reducing openings will have a bulk density that is reduced compared to a bulk density of a portion having the same bulk dimensions, that does not contain the weight-reducing openings.

As used herein, a “bulk density” refers to a density (mass per volume) of a portion of a takeout holder measured using a bulk volume of the portion. A bulk volume is a volume measured using exterior surfaces of the holder that is defined by a front surface, a back surface, and a perimeter defined by outer edges and any boundary of the portion that connects the portion with an adjacent portion of the holder. As shown at FIGS. 3A and 3C, for example, body portion 230 has a volume defined by front surface 232, back surface 234, side surfaces 236, an upper horizontal boundary between body 230 and connector 220 that is designated by dashed line 282, and a lower horizontal boundary that is designated by dashed line 280.

For purposes of measuring a volume and a density of a portion of a holder, a boundary between two portions of the holder (e.g., as designated by dashed lines 280 and 282), can be selected arbitrarily or naturally (e.g., based on an apparent structural end of a portion) but still consistent with the descriptions of the connector portion, the body portion, and the base portion. See also FIG. 2A showing a boundary between connector 120 and body 130 that aligns horizontally with a bottom of opening 124 between tabs 122, and a boundary between body 130 and base 140 that ends at vertical side connections of base 140 to body 130.

As an example, a bulk volume of connector 120 of FIGS. 2A and 2B is calculated as the volume of connector 120 measured between the full area of front surface 132, the full area of back surface 134, and using connector height, h(connector), between side surfaces 136, i.e., the volume of tabs 122 excluding opening 124. The bulk density of connector 120 is the mass of the tabs, which includes the mass of the solidified feedstock that forms lattice members 172, and the absence of solidified feedstock at weight-reducing openings 170, divided by the bulk volume of connector 120 defined by its exterior surfaces, including the areas of weight reducing openings 170 at front surface 132 and back surface 134. The bulk volume of connector 120 is not reduced by the volume of the weight-reducing openings that extend from front surface 132 to back surface 134.

Similarly, a calculation of the bulk volume of body 130 is calculated as the entire volume between of the exterior form of body 130 measured between the full area of front surface 132, the full area of back surface 134, having a thickness of side surfaces 136, and using connector height, h(connector), that extends from an upper boundary of body 130 with a lower boundary of connector 120, and a lower boundary of body 130 with an upper boundary of base 140. The bulk volume of body 130 includes the space between these areas, including space of weight-reducing openings 170.

As a result of the weight-reducing openings in a portion of a holder, a portion of a holder has a bulk density that is substantially less than a “material density” of the solid material of the portion of the holder.

A “material density” of a portion of a holder is the density (mass per volume) of the solid material (solidified feedstock material) that forms the portion of the holder. This value is a function of the material that makes up the portion of the holder, which may be a metal, ceramic, or a composite that contains metal or ceramic and an additional material. The material density of a solid material of a portion of a holder will be greater than the bulk density of the portion, because the portion of the holder contains weight-reducing openings. A material density of the solid material of the portion is calculated by dividing the mass of a sample of the material by the volume of the sample.

According to useful or preferred example takeout holders, a bulk density of a portion of a holder (e.g., connector, body, or base) may be less than 95 percent, 90 percent, or less than 85, 80, 70, 75, or 60 percent of the material density of the portion.

A takeout holder as described, that includes one or more weight-reducing openings, can be formed by certain specific types of additive manufacturing techniques, including certain types of additive manufacturing techniques that: do not involve feedstock that contains or requires polymer, and that do not require “post-processing” steps of sintering or polymer removal such as a “debind” step.

As used herein, the term “sintering” has a meaning that is consistent with the meaning that this term is given when used in the additive manufacturing arts. Consistent therewith, the term “sintering” refers to a process of bonding (e.g., “welding” or “fusing”) together a collection of feedstock particles that have been formed into a composite by additive manufacturing steps, by applying heat to the composite so that the particles reach a temperature that causes the particles to become fused together, i.e., welded together, by a physical bond between particles surfaces, but that does not cause particles to melt (i.e., the particles do not reach a melting temperature of the material of the particles).

Broadly considered, additive manufacturing techniques include a wide range of different general and specific versions of this technology. Additive manufacturing methods generally involve a series of individual layer-forming steps that sequentially form layer-upon-layer of solidified feedstock material derived from feedstock composition, to produce a “multi-layer composite.” A multi-layer composite formed by this initial step of layer formation can be referred to as an “initially-formed” multi-layer composite. The initially-formed multi-layer composite may be a finished or nearly-finished body that requires little or no additional processing, or may be a body (referred to sometimes as a “green body” or “green form”) that requires additional non-machining processing steps such as a binder-removal step, chemical curing step, or a sintering step, which are referred to as “post-processing” steps.

The different types of additive manufacturing techniques can be distinguished in various different respects, including, for example: the type and composition of the feedstock used to form the multi-layer composite; the types and range of materials (e.g., metals, ceramics, composites, polymers) that can be used to form a multi-layer composite; the method of forming the multiple layers from feedstock; and the degree of finish of the initially-formed multi-layer composite with respect to the need or absence of need for “post-processing” steps such as a polymer (binder) removal step, a chemical hardening or curing step, or a sintering (heating) step performed on an initially-formed body, or optional or required amounts of machining.

Different additive manufacturing techniques allow for preparing an initially-formed body with different physical properties, such as dimensional stability, density (the presence and amount of pores within solidified feedstock), layer thickness, feature sizes (minimum dimensions of features), and whether a technique can be used to form a body with a hollow space at an interior, which is not true of many types of additive manufacturing techniques.

Regarding the feedstock, some additive manufacturing techniques use feedstock that includes a binder to hold feedstock particles together during a step of forming an initial multi-layer composite, and during subsequent steps of handling and processing the initially formed-body.

Examples of general types of additive manufacturing techniques include those commonly referred to as “powder-bed” additive manufacturing methods, which include various “binder jet printing” techniques. Other examples include stereolithography techniques (SLS) and “feedstock dispensing methods” (FDMs).

Many powder-bed additive manufacturing methods, and other known additive manufacturing techniques, use a feedstock composition that contains a binder, such as a polymer. Typically, an initially-formed multi-layer composite prepared by one of these methods is not a completed item but is a “green body” or “green form” that contains the binder and that requires a post-processing steps such as debinding to remove the binder. The green body may also require an additional post-processing step such as a sintering step or a chemical curing step that may include exposure of the green body to elevated temperature or to irradiation. Certain types of additive manufacturing techniques, including powder-bed techniques, are also not useful to form a multi-layer composite that has a hollow interior space, because un-reacted feedstock will be contained within a space that is enclosed during layer-forming steps of the additive manufacturing process.

According to this description, certain specific types of additive manufacturing techniques have been identified as useful and capable of preparing a takeout holder as described, that contains weight-reducing openings in the form of a hollow interior space, or in the form of pores, or in the form of a lattice structure, and that is formed during a layer-forming step with no need for a post-processing step such as: a chemical curing step, a polymer removal step, a sintering step, or two or more of these.

Examples of specific methods that have been identified as capable for forming these types of takeout holders, as described, include the use of a laser or electromagnetic radiation to form a layer of solidified feedstock from a feedstock composition that contains feedstock particles but that does not require a binder and may specifically exclude a binder, e.g., may contain less than 5, 3, 2, or 1 weight percent polymeric binder based on total weight of feedstock composition.

Examples of these types of additive manufacturing techniques are referred to as: selective laser melting (SLM), electron beam melting (EBM), selective laser sintering (SLS), “direct metal deposition,” “laser metal deposition,” direct energy deposition, among others. These additive manufacturing techniques involve the use of a laser and feedstock composition (as powder or wire) to continuously form a “weld pool” on a surface, with the weld pool continuously solidifying to form a new surface on which a new weld pool can be formed to continuously form multiple layers of a multi-layer composite. This series of forming a weld-pool, which solidifies to form a solidified feedstock layer, then multiple additional solidified feedstock layers on a surface of a previously-formed layer, may be referred to as a “layer-forming step” or a series of “layer-forming steps.”

These methods form a precise body as an initially-formed composite that does not require a post-processing step of: chemical curing, sintering, or debinding. The initially-formed composite does not contain polymer that must be removed by a debinding step, and that does not require a subsequent sintering step or curing step to further process the multi-layer composite. These techniques produce a well-defined, high density structure that may be formed to near final dimensions of a takeout holder, that, therefore, does not require more than a normal or minor amount of post-process machining.

Accordingly, a holder as described can be prepared by one of these preferred additive manufacturing technique, that does not use binder in a feedstock, and that does not require a post-processing binder-removal step, a post-processing chemical cure step, or a post-processing heat-treatment (e.g., sintering) step. These useful methods use a series of additive manufacturing steps, with each step forming a single layer of a structure, by forming multiple layers of solidified feedstock sequentially onto a previous layer to produce a structure that is referred to herein as a multi-layer composite (or “composite”). As used herein, the term “composite” (or “multi-layer composite”) refers to a structure formed by additive manufacturing by sequentially forming a series of multiple individual and individually-formed layers of solidified feedstock. The composite takes the form of a takeout holder or a component of a takeout holder of the present description such as a connector portion (“connector”), a body portion (“body”), or a base portion (“base”).

According to example takeout holders prepared by an additive manufacturing technique as described, the entire holder, including the connector, body, and base, can be formed and held together exclusively as a structure of multiple layers formed by multiple layer-forming steps of an additive manufacturing method. In preferred holder can be made as a single piece as opposed to separate parts or portions of a holder that are subsequently secured into a single takeout holder device by use of a bonding step such as a vacuum brazing step that bonds together two or more separately-produced pieces. A takeout holder that is formed as a multi-layer composite by an additive manufacturing method, without bonding (by vacuum brazing, or the like), may be referred to herein as a “continuous” takeout holder.

The term “continuous” in this context means that a complete takeout holder is formed as a single-piece composite structure from multiple sequentially-formed layers. The term “continuous” does not refer to a structure that is prepared by separately forming two or more individual pieces and then bonding the separately-formed pieces together, for example by a vacuum brazing technique or by a different type of bonding technique. A continuous takeout holder will not include a seam or a boundary that results from a bonding step, especially a seam or boundary that is made of a bonding or filler material that has a composition that is different from the materials of the takeout holder.

One specific example of an additive manufacturing technique useful for forming a holder as described is the technique commonly referred to as “selective laser melting.” Selective laser melting (SLM), also known as direct metal laser melting (DMLM) or laser powder bed fusion (LPBF), is a three-dimensional printing method (additive manufacturing method) that uses a high power-density laser to melt solid particles of a feedstock material. The feedstock material preferably contains solid particles of metal, ceramic, or a metal or ceramic composite, and does not contain or require a significant amount of other material such as a binder (e.g., polymeric binder), which would be removed after formation of the multi-layer composite. The laser melts the particles of the feedstock and the melted (liquid) material of the particles flows to form a layer of the melted feedstock material, which is then allowed to cool and solidify to form a layer of solidified feedstock. According to certain particular example methods, the particles of the feedstock can be fully melted to form a liquid (i.e., liquefied), and the liquid material is allowed to flow to form a substantially continuous, substantially non-porous (e.g., less than 20, 15, 10, or 5 percent porosity) film that then cools and hardens as a solidified feedstock layer of a multi-layer composite.

The described additive manufacturing techniques may be useful for forming takeout holders made from a broad range of materials, including metal materials (including alloys), metal matrix composite materials, ceramic materials, and combinations of these.

With an additive manufacturing technique as described, including selective laser melting techniques, the range of possible metals, alloys, and metal matrix composites that can be used to form a takeout holder can advantageously include materials that are not easily formed into a useful takeout holder by previous techniques such as machining techniques. The range of materials available with additive manufacturing techniques includes metals and metal alloys that can be melted by laser energy, such as aluminum alloys, iron-based alloys (stainless steel alloys) titanium alloys, nickel and nickel-based alloys, and various metal matrix composite materials, some of which are not easily processed by machining. Example materials may exhibit such high hardness that the materials can be difficult to process by machining techniques to form precise structures of a takeout holder, including precise dimensions of lattices that form weight-reducing openings. Using additive manufacturing techniques, these materials can be processed to form a takeout holder that includes various forms of small-dimension lattices, hollow interior space, or both, that function as weight-reducing openings, even from materials that would be difficult to similarly form by using standard machining techniques.

The term “metal” is used herein in a manner that is consistent with the meaning of the term “metal” within the metal, chemical, and additive manufacturing arts, and refers to any metallic or metalloid chemical element or an alloy that includes two or more of these elements.

The term “metal matrix composite” (“MMC”) refers to a composite material that has been prepared to include at least two constituent parts or two phases, one phase being a metal or metal alloy and another phase that is a different metal or another non-metal material such as a fiber, particle, or whisker, that is dispersed through a metallic matrix. The non-metal material may be carbon-base, inorganic, ceramic, etc. Some example metal matrix composite materials are made of combinations of: an aluminum alloy with alumina particles; an aluminum alloy with carbon; an aluminum alloy with silicon; an aluminum alloy with silicon carbide (SiC); a titanium alloy with TiB2; a titanium alloy with silicon; a titanium alloy with silicon carbide (SiC).

Metal and metal alloys that may be useful according to methods of the present description include metal and metal alloys that have in the past been used for preparing takeout holder structures, and, additionally, other materials that have not. Useful or preferred materials include metals such as iron alloys (e.g., stainless steel and other types of steel), titanium and titanium alloys, nickel and nickel alloys (e.g., Hastelloy C22, Hastelloy C276), aluminum and aluminum alloys, molybdenum and molybdenum alloys, and various metal matrix composite materials.

By an additive manufacturing method, a complete (or substantially complete) functional takeout holder can be prepared using a single manufacturing process (a single layer-forming step or a single series of layer-forming steps), which offers high manufacturing efficiency in a reduced amount of time per unit (high manufacturing throughput). A takeout holder that is complete with substantially all required structures may be prepared by a single series of layer-forming steps. For example, what can be referred to as a “one-step” additive manufacturing process can form many, most, or all required structures of the takeout holder as a single, multi-layer composite as described. A one-step additive manufacturing process avoids the need to form multiple separate pieces individually by separate steps, followed by a still additional step of bonding the multiple, separately-formed pieces together to form a functional takeout holder structure, or curing, removing binder from, or heat-treating the initially-formed composite.

Still further, the described additive manufacturing techniques can be used to form a takeout holder that has high-precision dimensions, or varied dimensions or shapes, including shapes or varied dimensions that are difficult to form by conventional techniques, including weight-reducing openings in the form of a hollow interior, a lattice structure, or both.

Particles that are useful in a feedstock of the present description may be any particles that can be processed to form a useful multi-layer composite as described. Examples of useful particles include inorganic particles that are capable of being completely melted, partially melted (e.g., sintered), or liquefied, by laser energy to form a layer of a takeout holder as described. Examples of such particles include inorganic particles that are made of metals (including alloys), ceramic, or metal matrix composites. Some useful examples, generally, include metals and metal alloys such as stainless steel, nickel-based alloys, aluminum and aluminum alloys, and titanium and titanium alloys, as well as metal matrix composites.

Useful particles of a feedstock can be of any size (e.g., mean particle size) or size range that is effective, including small or relatively small particles on a scale of microns (e.g., having an average size of less than 500 microns, less than 100 microns, less than 50 microns, 10 microns, or less than 5 microns).

The particles can be selected to achieve effectiveness in processing as described, to be capable of being contained in a feedstock, formed into a feedstock layer, and fully melted or partially melted (e.g., sintered) to form a layer that contains the melted particles, that can cool to form solidified feedstock as a layer of a multi-layer composite. The size, shape, and chemical makeup of the particles can be any that are effective for these purposes.

The particles can be in the form of a feedstock composition that can be used in an additive manufacturing process as described. According to examples, feedstock useful in an additive manufacturing process may contain inorganic particles that are capable of being heated to be partially melted or fully melted then cooled to form a solidified feedstock layer of a multi-layer composite. The feedstock material is not required to contain any material other than the inorganic (e.g., ceramic, metal, or composite) particles, and may specifically exclude any binder (e.g., polymeric binder) that would be included in other types of feedstock compositions and processed by a post-processing step such as a binder curing step or a binder removal (debinding) step.

Example feedstock compositions for use in an additive manufacturing technique as described (e.g., a selective laser melting or selective laser sintering technique) may contain at least 80, 90, or 95, 98, or 99 percent inorganic particles by weight, based on total weigh of a feedstock composition. Other ingredients may be present if desired, at low amounts, such as one or more of a flow aid, surfactant, lubricant, leveling agent, or the like.

Each layer of a multi-layer composite may be formed to have any useful thickness. A thickness of a layer of a multi-layer composite is measured of a layer of the composite after the layer has been formed by melting particles of a feedstock layer to form a melted feedstock layer, and then cooled to form a solidified feedstock layer of the composite. Example thicknesses of a solidified layer of a composite may be in a range from 30 microns to 100, 200, or more microns, e.g., from 30 to 50, 60, 70, 80, microns up to 90, 100, 150, 200, 300, 400, or 500 microns. In example composite structures, all layers of the composite may have the same thickness or substantially the same thickness. In other example composite structures, the layers may not all have the same thickness, but different layers of the composite may each have different thicknesses.

1. A glass handler holder that comprises:
a connector that comprises at least one tab,
a body connected to the connector and extending toward a base,
a base that includes an insert opening comprising a lower surface and an upper surface,
the glass handler holder comprising a multi-layer composite that includes weight-reducing openings formed in the connector, body, or base.

2. The holder of claim 1 wherein the connector or body includes weight-reducing openings.

3. The holder of claim 1 wherein the weight-reducing openings comprise a hollow space at an interior of the connector, body, or base.

4. The holder of claim 3, comprising from 10 to 40 percent weight-reducing openings at the interior of the connector, body, or base.

5. The holder of claim 1, wherein the weight-reducing openings comprise irregularly-shaped pores within the multi-layer composite.

6. The holder of claim 5, comprising from 10 to 40 percent weight-reducing openings at the interior of the connector, body, or base.

7. The holder of claim 1, wherein the weight-reducing openings comprise lattice openings in a lattice structure.

8. The holder of claim 7, wherein the lattice structure comprises from 10 to 40 percent weight-reducing openings.

9. The holder of claim 1, wherein the holder comprises from 10 to 40 percent weight-reducing openings based on total volume of the holder.

10. The holder of claim 1, wherein a bulk density of the holder is less than 90 percent of the material density of the holder.

11. The holder of claim 1, wherein the multi-layer composite comprises a metal or metal alloy, a metal composite matrix, or a ceramic.

12. The holder of claim 11, wherein the multi-layer composite comprises a metal selected from: a titanium alloy, stainless steel, a nickel alloy, and an aluminum alloy.

13. The holder of claim 1, comprising a non-metal insert held within the insert opening, the insert comprising a surface adapted to contact a hot glass surface.

14. The holder of claim 1, comprising the connector operatively connected to a robot arm of an automated hot glass handling system.

15. A method of making a glass handler holder by additive manufacturing,
the glass handler holder comprising:
a connector that comprises at least one tab,
a body connected to the connector and extending toward a base,
a base that includes an insert opening comprising a lower surface and an upper surface,
the glass handler holder comprising a multi-layer composite that includes weight-reducing openings formed in the connector, body, or base.

16. The method of claim 15 comprising forming solidified feedstock by melting inorganic particles using a laser.

17. The method of claim 15, wherein the feedstock layer comprises inorganic particles selected from: metal or metal alloy particles, metal composite matrix particles, and ceramic particles.

18. The method of claim 17 wherein the feedstock layer comprises at least 90 percent inorganic particles.

19. The method of claim 15, wherein the weight-reducing openings comprise hollow interior space.

20. The method of claim 15 wherein the method forms the glass handler holder, without a step of removing polymeric binder from the multi-layer composite.
